(19) United States
(12) Patent Application Publication
(10) Pub. No.: US 2014/0233379 A1
(43) Pub. Date: Aug. 21, 2014

(54) USER SCREENING METHOD AND BASE STATION FOR USER SCREENING

(71) Applicant: HUAWEI TECHNOLOGIES CO., LTD., Shenzhen (CN)

(72) Inventors: Jiandong CHU, Shanghai (CN); Shijin Han, Shenzhen (CN)

(73) Assignee: HUAWEI TECHNOLOGIES CO., LTD., Shenzhen (CN)

(21) Appl. No.: 14/263,304

(22) Filed: Apr. 28, 2014

Related U.S. Application Data
(63) Continuation of application No. PCT/CN2012/083648, filed on Oct. 29, 2012.

(30) Foreign Application Priority Data
Oct. 28, 2011 (CN) 201110335142.X

(51) Int. Cl. H04W 28/02

(52) U.S. Cl. CPC H04W 28/0289
USPC 370/230

(57) ABSTRACT

The present invention relates to a user screening method and a base station for user screening. The method includes: judging whether the number of users detected within a current TTI exceeds an upper limit of the number of users capable of being processed within the current TTI; and if the upper limit is exceeded, discarding users corresponding to preamble sequences generated by a same root sequence. Whether a current load condition is a high load is known by judging whether the number of users detected within the current TTI exceeds the upper limit of the number of users capable of being processed within the current TTI, and the users detected under a high load condition are detected and discarded, so that a random access false alarm flow caused by interference signals is effectively controlled.

### CROSS-REFERENCE TO RELATED APPLICATIONS

This application is a continuation of International Application No. PCT/CN2012/083648, filed on Oct. 29, 2012, which claims priority to Chinese Patent Application No. 201110335142.X, filed on Oct. 28, 2011, both of which are hereby incorporated by reference in their entireties.

### TECHNICAL FIELD

The present invention relates to a radio communication technology, and in particular, to a user screening method and a base station for user screening.

### BACKGROUND

A random access channel (Random Access Channel, RACH) is mainly used for initial access of network access. In a long term evolution (Long Term Evolution, LTE) system, a RACH does not carry any user equipment data, and is mainly used to enable a user equipment that does not implement or has lost uplink synchronization to implement uplink timing synchronization.

A RACH corresponding to a physical layer is referred to as a physical random access channel (Physical Random Access Channel, PRACH). An access user sends a random access sequence according to time-frequency resources configured by a base station, and the base station periodically detects, according to the same time-frequency resource configuration, the random access sequence transmitted by the user. During the detection, the base station performs correlation calculation by using a configured root sequence and received signal, and judges, by judging whether a peak value obtained after the correlation calculation exceeds a threshold, whether there is a user requiring access. The threshold setting may be obtained by simulation according to a certain channel model. However, unexpected interference exists during actual use of the base station. Therefore, a false alarm probability always exists in the actual use, that is, a non-existent user may be detected.

The random access sequence is generated according to a cyclic shift value configured for a cell in the base station and a root sequence indicated by a root sequence start index, and each cell may have at most 64 random access sequences. Because the cyclic shift values are different, the numbers of used root sequences are also different. If a single root sequence is not enough for generating a specific number of random access sequences of the cell, a next root sequence from the root sequence start index is used.

After the base station detects the random access sequence at the physical layer, the base station considers that there is a user equipment that accesses the base station. Afterward, the base station does not perform validity screening on the detected access user, but directly reports the detected access user to a higher layer for processing, and a next procedure is performed. The higher layer only directly discards, according to its own processing capabilities, the access user subsequently reported by the physical layer when the number of access users to be processed reaches a maximum value. As a result, access of other real user equipments is affected, and the load of the system is always in a high load state.

### SUMMARY

Embodiments of the present invention provide a user screening method and a base station for user screening, so as to control a random access false alarm flow under a high load condition.

In one aspect, an embodiment of the present invention provides a user screening method, including:

judging whether the number of users detected within a current TTI transmission time interval exceeds an upper limit of the number of users capable of being processed within the current TTI; and

if the upper limit is exceeded, discarding users corresponding to preamble sequences generated by a same root sequence.

In another aspect, an embodiment of the present invention further provides a base station for user screening, including:

a judging unit, configured to judge whether the number of users detected within a current TTI transmission time interval exceeds an upper limit of the number of users capable of being processed within the current TTI; and

a first processing unit, configured to: when the judging unit determines that the number of users detected within the current TTI exceeds the upper limit of the number of users capable of being processed within the current TTI, discard users corresponding to preamble sequences generated by a same root sequence.

By using the user screening method and base station for user screening according to the embodiments of the present invention, when it is judged that the number of users detected within the current TTI exceeds the upper limit of the number of users capable of being processed within the current TTI, specific users are discarded, so that false alarms are reduced effectively. Meanwhile, by discarding specific users, the impact on the processing load of a higher layer is reduced, and system performance is improved effectively.

### BRIEF DESCRIPTION OF DRAWINGS

To describe the technical solutions in the embodiments of the present invention more clearly, the following briefly introduces the accompanying drawings required for describing the embodiments of the present invention. Apparently, the accompanying drawings in the following description show merely some embodiments of the present invention, and persons skilled in the art may still derive other drawings from these accompanying drawings without creative efforts.

FIG. 1 is a flowchart of a user screening method according to an embodiment of the present invention;

FIG. 2 is a schematic diagram of a sequence correlation simulation result;

FIG. 3 is a flowchart of a user screening method according to another embodiment of the present invention;

FIG. 4 is a flowchart of another user screening method according to an embodiment of the present invention;

FIG. 5 is a schematic structural diagram of a base station for user screening according to an embodiment of the present invention; and

FIG. 6 is a schematic structural diagram of another base station for user screening according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

FIG. 1 is a flowchart of a user screening method according to an embodiment of the present invention. In this embodiment, an execution subject may be a base station, or a module or an apparatus disposed on a base station or connected to the base station. As shown in FIG. 1, the user screening method includes:

Step 11: Judge whether the number of users detected within a current transmission time interval (Transmission Time Interval, TTI) exceeds an upper limit of the number of users capable of being processed within the current TTI.

Normally, the upper limit of the number of users capable of being processed within the current TTI may be determined according to the system load and time sequence requirements, and is not limited by the present invention.

Step 12: If the upper limit is exceeded, discard users corresponding to preamble sequences generated by a same root sequence.

If a judgment result in step 11 is that the number of users detected exceeds the upper limit of the number of users capable of being processed by a device or system within the current TTI, discard processing is performed. It may be understood that, the discard processing herein may be not reporting the users to an upper layer, normally, Layer 2 (layer 2), that is, a media access control (Media Access Control, MAC) layer.

If the judgment result in step 11 is that the number of users detected does not exceed the upper limit of the number of users capable of being processed by the device or system within the current TTI, the step of discarding users is not performed. Therefore, processing may be performed according to a normal operation: reporting the users to the upper layer, normally, the Layer 2 (layer 2), that is, the MAC layer.

In this embodiment, when it is judged that the number of users detected within the current TTI exceeds the upper limit of the number of users capable of being processed within the current TTI, specific users are discarded, so that false alarms are reduced effectively. Meanwhile, by discarding specific users, the impact on the processing load of a higher layer is reduced, and system performance is improved effectively.

In another embodiment of the present invention, on the basis of the above embodiment, the discarding users corresponding to preamble sequences generated by a same root sequence may specifically be: discarding, according to occurrence frequencies of the users, the users corresponding to the preamble sequences generated by the same root sequence.

It may be understood that, a preamble sequence index is an index of a preamble sequence, and preamble sequence indexes correspond to preamble sequences on a one-to-one basis. In this application, not only the preamble sequence may be used to determine the corresponding user, but also the preamble sequence index may be used to determine the corresponding user, and both are essentially the same and are not limited by the present invention.

The random access sequence is generated according to a cyclic shift value and a root sequence start index that are configured for a cell, and each cell may have at most 64 random access sequences. Specifically, after implementing downlink synchronization, the user equipment parses a system message broadcast by the cell of the base station. The user equipment obtains PRACH configuration of the cell of the base station from the system message where the PRACH configuration includes a root sequence (838 optional root sequences specified by a protocol) index and a cyclic shift value (Ncs), and a subframe position and a frequency-domain position that allow sending a random access sequence. Using the configured root sequence as a basis, the user equipment randomly selects a preamble sequence index (Preamble ID) (in some scenarios, a preamble sequence index is distributed by the base station), and in combination with the cyclic shift value, cyclically shifts the root sequence to obtain the random access sequence used by the current random access. The value range of the preamble sequence index is 0-63, indicating times of shifting the root sequence; and the cyclic shift value is the number of bits shifted every time.

When the base station detects the random access sequence, the base station periodically detects signals in the subframe position and the frequency-domain position where the user equipment is allowed to send the random access sequence. The specific method is performing a correlation operation with the configured root sequence. The Preamble ID may be calculated according to the position of a valid peak value in the sequence after the correlation, and an air interface delay value may be calculated, so that uplink synchronization adjustment may be performed.

Because the cyclic shift values are different, the numbers of used root sequences are also different. If a single root sequence is not enough for generating the number of random access sequences of the cell, a next root sequence from the root sequence start index is used.

The inventor finds that the preamble sequence index (Preamble ID) of a false alarm is relatively fixed. From a correlation simulation result of an SRS (Sounding Reference Signal, sounding reference signal also referred to as a sounding pilot) sequence of a neighboring cell under a specific PCI and the root sequence of the current cell, it can be seen that the correlation value of the two sequences is very high. After the correlation, many peak values exceeding a detection threshold of the random access sequence are obtained in the sequence, and it may be determined that there are user equipments requiring access because the detection threshold is exceeded. In addition, the detected preamble sequence indexes are relatively regular, and are fixed to several index numbers. In the case that SRS fixed interference and similar fixed interference exist for a long time, there is a high false alarm probability in detection of random sequences for a long time.

For analysis of an interference source, according to the field problem feedback and the correlation simulation result, when the PRACH configuration of the current cell has time-frequency positions coinciding with those of the SRS of the neighboring cell and a physical cell ID (PCI) of the neighboring cell satisfies a certain requirement, the SRS signal of the neighboring cell satisfying a certain rule becomes a fixed interference source of the current cell, resulting in a high false alarm probability of the PRACH of the current cell. In addition, the preamble sequence index (Preamble ID) of a false alarm is relatively fixed. The physical cell ID decides configuration of the SRS signal.

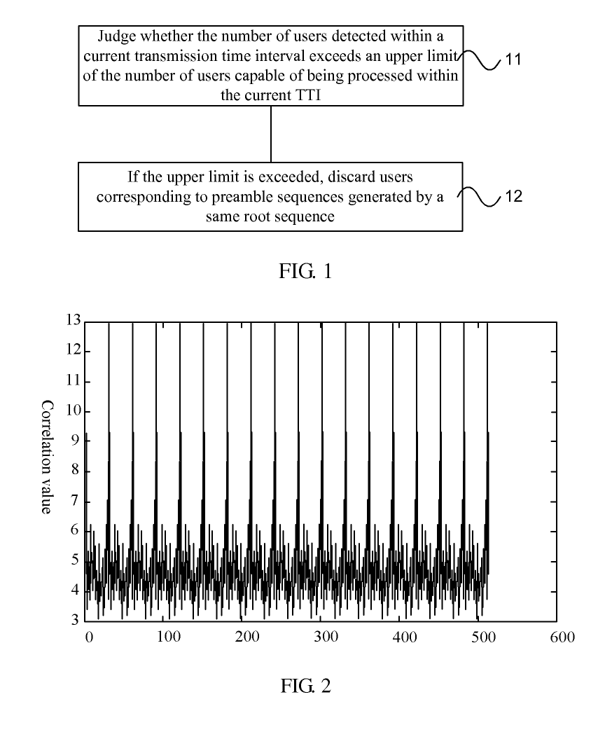

FIG. 2 shows a simulation result of an SRS received signal and the root sequence under the specific PCI. From FIG. 2, it can be seen that the correlation value of the two sequences is relatively high and tends to exceed the detection threshold of the random access sequence. Therefore, non-existent users are detected, and the detected users are relatively regular, and the preamble sequence indexes are fixed on several index numbers.

The user screening method provided by the embodiment of the present invention may further include:

judging whether the number of users detected within the current TTI exceeds the upper limit of the number of users capable of being processed within the current TTI; and

if a judgment result is that the number of users detected within the current TTI exceeds the upper limit of the number of users capable of being processed within the TTI, discarding users whose signal quality measurement values are lower than a preset threshold until the number of remaining users does not exceed the upper limit of the number of users capable of being processed within the current TTI.

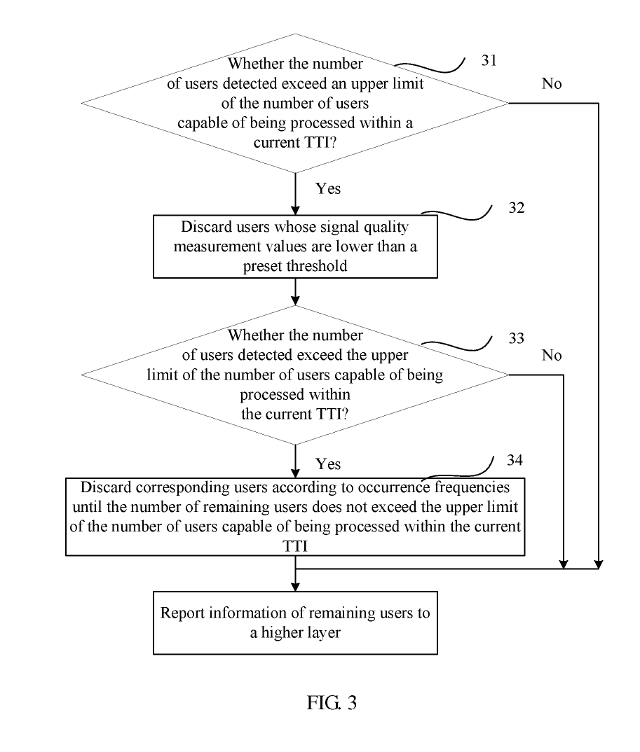

FIG. 3 is a flowchart of a user screening method according to another embodiment of the present invention. As shown in FIG. 3, the user screening method includes:

Step 31: A base station judges whether the number of users detected within a current TTI transmission time interval exceeds an upper limit of the number of users capable of being processed within the current TTI; and if the upper limit is exceeded, executes step 32; otherwise, performs processing according to a normal method, for example, directly reporting information of the remaining users to an upper layer.

Step 32: The base station discards users whose signal quality measurement values are lower than a preset threshold.

Step 33: The base station judges again whether the number of users detected within the current TTI transmission time interval exceeds the upper limit of the number of users capable of being processed within the current TTI; and if so, executes step 34; otherwise, performs processing according to the normal method, for example, reporting information of the remaining users to the upper layer.

Step 34: The base station first discards users with high occurrence frequencies among users corresponding to preamble sequences generated by a same root sequence, and then discards users with low occurrence frequencies among the users corresponding to the preamble sequences generated by the same root sequence until the number of remaining users does not exceed the upper limit of the number of users capable of being processed within the current TTI.

In this embodiment, when the base station determines that the number of users detected within the current TTI exceeds the upper limit of the number of users capable of being processed within the current TTI, the base station first discards the users whose signal quality measurement values are lower than the preset threshold, and then discards the users with high occurrence frequencies among the users corresponding to preamble sequences generated by the same root sequence, so that random access false alarms caused by interference signals are further controlled.

It may be appreciated that, the high or low frequencies mentioned in this embodiment mean high or low frequencies obtained by ranking the frequencies of users within the current TTI and comparing occurrence frequencies of the users, and may not indicate absolute values of the frequencies.

It may be understood that, both the following methods may implement user screening in the present invention: discarding the users whose signal quality measurement values are lower than the preset threshold to screen the users within the current TTI, and discarding the users with high occurrence frequencies among the users corresponding to the preamble sequences generated by the same root sequence to screen the users within the current TTI. The present invention does not limit the order of using the two methods, and the order may be adjusted.

For example, in another embodiment, the step of discarding the corresponding users according to the frequency of the preamble sequence index of the same random access sequence generated by the same root sequence may be executed first, and after this step, the method includes:

judging whether the number of users detected within the current TTI exceeds the upper limit of the number of users capable of being processed within the current TTI; and

if a judgment result is that the number of users detected within the current TTI exceeds the upper limit of the number of users capable of being processed within the TTI, discarding users whose signal quality measurement values are lower than the threshold until the number of remaining users does not exceed the upper limit of the number of users capable of being processed within the current TTI, for example, discarding users whose signal to interference plus noise ratio measurement values are lower than the threshold.

FIG. 4 is a flowchart of another user screening method according to an embodiment of the present invention. In this embodiment, the upper limit of the number of users processed within each TTI is limited. In addition, when the number of users detected within the current TTI exceeds the upper limit of the number of users, the upper limit of the number of users processed within each TTI and belonging to the same root sequence is limited.

When the number of users detected within each TTI reaches the upper limit of the number of users, a user screening procedure is started: When a sequence is generated by the same root sequence, the historical occurrence frequencies of users detected within the current TTI may be known according to a detected historical value record, and then users of the preamble sequence indexes generated by the same root sequence among the detected users are discarded according to the occurrence frequencies, for example, users with high occurrence frequencies are first discarded, and then users with low occurrence frequencies are discarded until the number of remaining users is smaller than or equal to the upper limit of the number of users that is limited by the root sequence. According to the above screening principle, when the number of users still exceeds the upper limit or all users belong to different root sequences, selection or discard is determined according to a signal to interference plus noise ratio (Signal to Interference plus Noise Ratio, SINR). Several users with the lowest SINR are discarded. Specifically as shown in FIG. 4, the method includes:

Step 41: When detection within the current TTI is completed at a physical layer, judge whether the number of users exceeds a threshold, and if the threshold is exceeded, execute step 42 to start a screening procedure; otherwise, execute step 45, where the threshold may be a preset upper limit of the above number of users.

Step 42: Screen a Preamble ID under each root sequence, and discard users according to historical occurrence probabilities until the number of users is smaller than or equal to the upper limit of the number of users that is limited by each root sequence.

Step 43: Judge whether the number of remaining users exceeds a processing threshold, and if so, execute step 44; otherwise, execute step 45, where the processing threshold may be the preset upper limit of the above number of users.

Step 44: Perform screening according to a signal to interference plus noise ratio (SINR), discard users with low SINRs until the processing threshold is satisfied.

Step 45: Report information of the remaining users to a higher layer, that is, a media access control layer in layer 2 of a radio access standard protocol.

In the above embodiment, under a high load condition, that is, when system processing threshold is exceeded, validity screening is performed on the users. Therefore, an LTE system filters users of false alarms by using the method of comparing historical statistic probabilities because the generated users of false alarms are relatively regular in the case that a fixed interference source (such as the above SRS signal of the neighboring cell) exists. Therefore, the adverse impact generated by users of false alarms is effectively suppressed, and access of real user equipments and the access probability of real user equipments in the case of interference are ensured.

Persons of ordinary skill in the art should understand that, all or part of the steps of the foregoing method embodiments may be implemented by a program instructing relevant hardware. The foregoing program may be stored in a computer readable storage medium. When the program is run, the foregoing steps included in the method embodiments are performed. The foregoing storage medium may be any medium capable of storing program codes, such as a ROM, a RAM, a magnetic disk, or an optical disk.

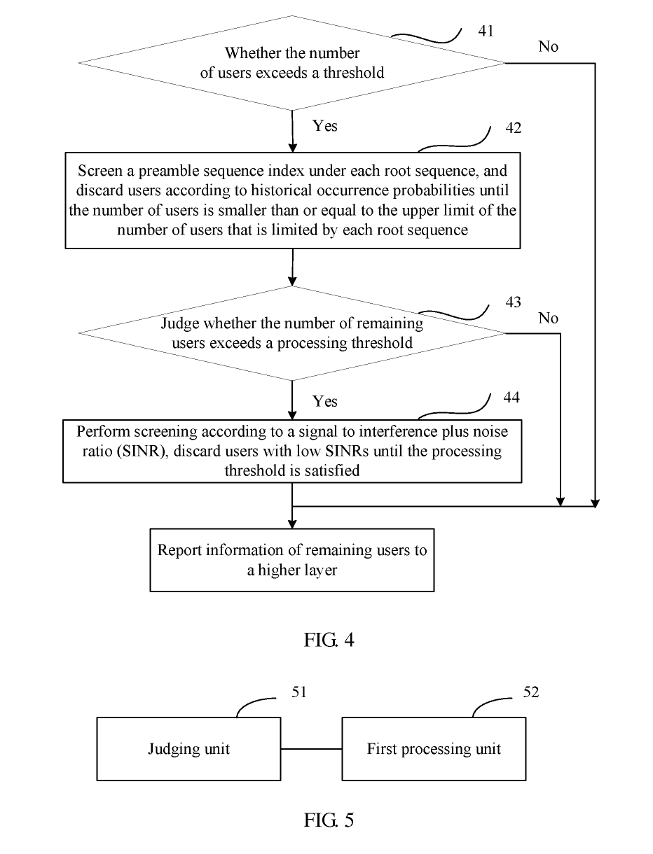

FIG. 5 is a schematic structural diagram of a base station for user screening according to an embodiment of the present invention. As shown in FIG. 5, the base station for user screening is configured to execute the method of the embodiment shown in FIG. 1, and includes: a judging unit 51 and a first processing unit 52, where the judging unit 51 is connected to the first processing unit 52.

The judging unit 51 is configured to judge whether the number of users detected within a current TTI exceeds an upper limit of the number of users capable of being processed within the current TTI; and the first processing unit 52 is configured to: when the judging unit 51 determines that the number of users detected within the current TTI exceeds the upper limit of the number of users capable of being processed within the current TTI, discard users corresponding to preamble sequences generated by a same root sequence. For example, the first processing unit 52 may be specifically configured to discard, according to occurrence frequencies of the users, the users corresponding to the preamble sequences generated by the same root sequence. For example, the first processing unit 52 may be specifically configured to arrange, in descending order, the occurrence frequencies of the users corresponding to the preamble sequences generated by the same root sequence, and discard the users according to the arrangement order. Specifically, users with high occurrence frequencies among the users corresponding to the preamble sequences generated by the same root sequence may be discarded first, and then users with low occurrence frequencies among the users corresponding to the preamble sequences generated by the same root sequence may be discarded. The first processing unit 52 may discard, according to the occurrence frequencies, the users corresponding to the preamble sequences generated by the same root sequence, for example, first discard the users with high occurrence frequencies and then discard the users with low occurrence frequencies until the number of remaining users is smaller than or equal to the upper limit of the number of users that is limited by the root sequence. According to the above screening principle, when the number of users still exceeds the upper limit or all users belong to different root sequences, the first processing unit 52 may discard again, according to signal quality measurement values, users whose signal quality measurement values are lower than the preset threshold.

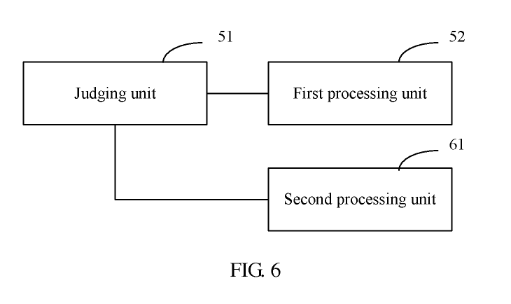

FIG. 6 is a schematic structural diagram of another base station for user screening according to an embodiment of the present invention. The base station in this embodiment is similar to that in the embodiment shown in FIG. 5, and the difference lies in that the base station in this embodiment further includes a second processing unit. As shown in FIG. 6, the base station is configured to execute the method in the embodiment shown in FIG. 3 and includes: a judging unit 51, a first processing unit 52, and a second processing unit 61, where the judging unit 51 is connected to the first processing unit 52 and the second processing unit 61.

The second processing unit 61 is configured to: if the judging unit 51 determines that the number of users detected within the current TTI exceeds the upper limit of the number of users capable of being processed within the TTI, discard users whose signal quality measurement values are lower than the preset threshold until the number of remaining users does not exceed the upper limit of the number of users capable of being processed within the current TTI. For example, the second processing unit 61 is specifically configured to discard, according to the SINR, users whose SINRs are lower than the preset threshold. For the specific operation, reference may be made to the description in the above method embodiments.

In the above embodiment of the base station, the base station knows, through the judging unit, whether the number of users currently detected exceeds the upper limit of the number of users, that is, whether the current load condition is a high load, and performs detection and discard processing, through the processing unit, on the users detected under the high load, thereby effectively controlling random access false alarms caused by interference signals, and solving the problem of discarding normal users that is caused by false alarms.

In the above method and apparatus embodiments, when the number of random access users of the system exceeds the threshold and the system load is high, validity screening is performed on the random access users, where the screening principle is: when a preamble sequence index is generated by the same root sequence, discarding users with the same preamble sequence index according to the detected historical value record and occurrence frequencies until the number of users to be processed is smaller than or equal to the limited upper limit of the number of users that is generated by the same root sequence; according to the above screening principle, when the number of users still exceeds the upper limit or all users belong to different root sequences, selection or discard is determined according to the measurement value SINR. Of course, users may also be first screened according to the user signal quality measurement value SINR, and then users with the same preamble sequence index may be discarded according to the occurrence frequencies of users. This is not limited in the embodiments of the present invention.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, as long as such modifications or replacements do not cause corresponding technical solutions to depart from the spirit and scope of the technical solutions of the embodiments of the present invention.

What is claimed is:

1. A user screening method, comprising:
judging whether the number of users detected within a current transmission time interval (TTI) exceeds an upper limit of the number of users capable of being processed within the current TTI; and
when a judgment result is that the upper limit is exceeded, discarding users corresponding to preamble sequences generated by a same root sequence.

2. The user screening method according to claim 1, wherein the discarding users corresponding to preamble sequences generated by a same root sequence comprises:
discarding, according to occurrence frequencies of the users, the users corresponding to the preamble sequences generated by the same root sequence.

3. The user screening method according to claim 2, wherein the discarding, according to occurrence frequencies of the users, the users corresponding to the preamble sequences generated by the same root sequence comprises:
arranging, in descending order, the occurrence frequencies of the users corresponding to the preamble sequences generated by the same root sequence, and discarding the users according to the arrangement order.

4. The user screening method according to claim 1, wherein when the judgment result is that the upper limit is exceeded, the method further comprises:
discarding users whose signal quality measurement values are lower than a preset threshold until the number of remaining users does not exceed the upper limit of the number of users capable of being processed within the current TTI.

5. The user screening method according to claim 4, wherein the discarding users whose signal quality measurement values are lower than a preset threshold specifically comprises: discarding users whose signal to interference plus noise ratio measurement values are lower than the preset threshold.

6. A base station for user screening, comprising:
a judging unit, configured to judge whether the number of users detected within a current transmission time interval (TTI) exceeds an upper limit of the number of users capable of being processed within the current TTI; and
a first processing unit, configured to: when the judging unit determines that the number of users detected within the current TTI exceeds the upper limit of the number of users capable of being processed within the current TTI, discard users corresponding to preamble sequences generated by a same root sequence.

7. The base station according to claim 6, wherein the first processing unit is specifically configured to discard, according to occurrence frequencies of the users, the users corresponding to the preamble sequences generated by the same root sequence.

8. The base station according to claim 7, wherein the first processing unit is specifically configured to arrange, in descending order, the occurrence frequencies of the users corresponding to the preamble sequences generated by the same root sequence, and discard the users according to the arrangement order.

9. The base station according to claim 6, further comprising:
a second processing unit, configured to: when the judging unit determines that the number of users detected within the current TTI exceeds the upper limit of the number of users capable of being processed within the TTI, discard users whose signal quality measurement values are lower than a preset threshold until the number of remaining users does not exceed the upper limit of the number of users capable of being processed within the current TTI.

10. The base station according to claim 9, wherein the second processing unit is specifically configured to discard users whose signal to interference plus noise ratio measurement values are lower than the preset threshold.
